(19) United States
(12) Patent Application Publication
(10) Pub. No.: US 2024/0149483 A1
(43) Pub. Date: May 9, 2024

(54) KNIFE HOLDER FOR CUTTING MACHINES

(71) Applicant: Dienes Werke für Maschinenteile GmbH & Co. KG, Overath (DE)

(72) Inventor: Tony CHIARVALOTI, West Brookfield, MA (US)

(21) Appl. No.: 18/504,396

(22) Filed: Nov. 8, 2023

(30) Foreign Application Priority Data
Nov. 8, 2022 (EP) 22206056.8

(51) Int. Cl. B26D 7/26

(52) U.S. Cl. CPC B26D 7/2621

(57) ABSTRACT

The invention relates to a knife holder (1) for cutting machines, with a knife carrier (2) rotatably mounted around an axis of rotation for holding a knife and a setting device (3) for the knife carrier (2), wherein the knife carrier (2) can be driven by the setting device (3) parallel to the axis of rotation (4) between a standby position and a cutting position, and wherein the knife holder (1) comprises a fixing device (5) that can be activated independently of the setting device (3), with which the knife carrier (2) can be fixed in the cutting position in the direction of the axis of rotation (3).

The present invention relates to a knife holder for cutting machines, with a knife carrier rotatably mounted around an axis of rotation for holding a circular knife, and to a setting device for the knife carrier, wherein the knife carrier can be driven by the setting device parallel to the axis of rotation between a standby position and a cutting position.

In particular, the knife holder is a knife holder for a longitudinal cutting machine, in which a plurality of identical knife holders are fastened to a traverse of the longitudinal cutting machine. In order to attach a knife holder to the traverse, a housing of the knife holder has an attachment device, which can be used to attach the knife holder to the traverse. For example, the attachment device can have a recess, with which the knife holder can be attached to a traverse with a dovetailed cross section. Other cross sectional configurations of the traverse and the corresponding recess of the attachment device can also be provided. The attachment device can comprise a fixing unit, which can be used to fix the knife holder to the traverse.

The fixing unit can be actuated mechanically, electrically, pneumatically and/or hydraulically.

One embodiment can provide that the knife holder comprises a lowering device, with which a knife head having the knife carrier can be moved orthogonally to the axis of rotation of the knife carrier to a counter-knife. In particular, the lowering device can be used to move the knife head in a lowering direction in particular to and from at least one bottom knife. It can also be provided that the knife holder has several knife heads each with a knife carrier, which together can be moved with exactly one lowering device relative to at least one bottom knife; in particular, each knife head can be moved to exactly one bottom knife. In particular, the knife head is here moved relative to the attachment device that can be attached to the traverse. For example, the lowering device can be realized by an electric motor (in particular a stepping motor) or preferably by a pneumatically or hydraulically actable piston/cylinder unit. In an alternative embodiment, the knife carrier can be rotatably mounted in the housing, for example which can be attached to the traverse, so that the knife carrier cannot be adjusted orthogonally to the axis of rotation.

The setting device can be used to adjust/move the knife carrier, and thus a circular knife carried by the knife carrier, parallel to the axis of rotation of the knife carrier, and hence parallel to the axis of rotation of the circular knife, to a cutting edge of a counter-knife. If the knife holder comprises a lowering device, one embodiment can provide that the setting device is part of the knife head, which can be adjusted/moved by the lowering device to the counter-knife orthogonally to the axis of rotation of the knife carrier. As a consequence, in particular a straight driving direction of the setting device is aligned orthogonally to the lowering direction. The setting device can thus be used to adjust the knife in its axial direction to a cutting edge of a bottom knife, in particular in a linear fashion.

Known from prior art is that the knife carrier, and hence the circular knife, can be adjusted both orthogonally to the axis of rotation by means of the lowering device and also parallel to the axis of rotation by means of the setting device to a counter-knife in a force-controlled manner, as a result of which the cutting force can be held constant during the cutting process. In particular, if the lowering device and/or the setting device are pneumatically activatable, however, it can happen that the knife performs an evasive motion during the cutting process owing to additional operating forces.

Known from DE 20 2006 010 874 U1 is a knife holder with the features of the preamble to claim 1, in which a piston rod of the lowering device can be fixed in the lowered position of the knife head, so that the knife cannot perform any evasive motion orthogonal to the axis of rotation of the knife during the cutting process.

The object of the present invention is to eliminate the disadvantages described with respect to prior art, and in particular to indicate a knife holder in which the knife carrier or the knife carried by the knife carrier is reliably held in the desired cutting position during the cutting process.

One solution to the object is indicated with the knife holder having the features of the independent claim. Additional solutions and advantageous further developments are indicated in the independent claims, as well as in the preceding and following description, wherein individual features of the advantageous further developments can be combined with each other in a technically reasonable manner.

In particular, the object is achieved by a knife holder with the features mentioned at the outset, which comprises a fixing device that can be actuated independently of the setting device, and can be used in particular to mechanically fix the knife carrier in the cutting position against a movement parallel to the axis of rotation.

In other words: The underlying idea of the invention is that the knife holder comprises a fixture referred to as a fixing device, with which the knife carrier can be fixed in the direction in which the knife carrier can be adjusted/moved relative to a counter-knife by the setting device, independently of the setting device. With the fixing device, the knife holder thus has a unit that can be activated independently of the setting device and possibly also independently of a lowering device, which fixing device in particular acts at least indirectly on an element of the setting device, so that the element of the setting device is fixed in its position in a fixed state of the fixing device. As a consequence, it is possible that the knife carrier can be moved by means of the setting device parallel to the axis of rotation into a cutting position, in particular in a force-controlled manner, wherein the knife carrier is reliably secured in the cutting position by means of the fixing device. It is here accepted that no force-controlled regulation of the cutting force is possible during the cutting process.

In a preferred embodiment, the fixing device non-positively and/or positively fixes the knife carrier in the cutting position. For a positive fixation, an undercut configuration or recess can be provided, into which an element of the fixing device engages, so that the component having the undercut configuration or the recess cannot be moved relative to the element of the fixing device. In particular, the undercut configuration or the recess can be formed on an element of the setting device. To establish a non-positive fixation of the knife carrier, at least one element of the fixing device can act with a relatively large force on an element connected with the knife carrier, so that the element is clamped by the at least one element of the fixing device.

In particular, the fixing device can be mechanically, electrically, pneumatically, or hydraulically activated/actuated. In particular, the fixing device can comprise at least one fixing element (i.e., precisely one fixing element or several fixing elements), which can be moved between a fixed state and a released state, wherein the knife holder is fixed in the fixed state, while the knife holder can be moved parallel to the axis of rotation by a drive of the setting device in the released state. For example, the at least one fixing element that interacts non-positively and/or positively with an additional element in the fixed state can be pretensioned by means of a spring, for example, and activatable by means of an electric, pneumatic, or hydraulic drive. It can here be provided that the at least one fixing element be pretensioned by means of the spring element in the fixed state, and can be moved into the released state by means of the drive. However, it can alternatively also be provided that the at least one fixing element be movable into the fixed state mechanically, electrically, pneumatically, or hydraulically. For example, the fixing element can be designed as a pin, brake shoe, clamping element, piston, cam and/or similar component.

The setting device for moving the knife carrier from the standby position into the cutting position and possible back again can comprise an actuator/a drive, which can be electrically, pneumatically, or hydraulically activated/actuated. For example, the drive/actuator can be designed as an electric motor, be a pneumatic or hydraulic piston/cylinder unit, and thereby realize the setting device.

In the case of a pneumatic activation of the setting device, the setting device can comprise at least one membrane, which can be pneumatically actuated for activating the setting device. A pressurized fluid, in particular compressed air, can be introduced in particular between the two membranes. The use of two membranes provides a simple way to provide an airtightly sealed chamber for introducing compressed air.

Alternatively, it can be provided for pneumatic activation that the setting device has a piston, which is exposed to direct pneumatic actuation. For example, the piston can be pressurized with compressed air on an end face for adjustment/movement in one direction. In addition, it can be provided that the piston has at least one annular protrusion that projects in a radial direction, the axial front surface of which can be pressurized with compressed air for actuating the piston. In particular, the pneumatically actable piston is the setting piston described further below.

In order to create an electrically actable actuator, an electric motor can be provided, by means of which the knife carrier can be moved electromechanically between the standby position and the cutting position parallel to the axis of rotation. The electric motor is preferably a stepping motor.

In particular, the setting device can comprise a setting piston, on which the knife carrier is rotatably mounted. The actuator of the setting device acts indirectly or directly on the setting piston, so as to move the knife carrier between the cutting position and the standby position. In particular, the setting piston comprises a bearing section, with which the setting piston is mounted in a linearly displaceable manner in a sleeve-shaped bearing in the direction of or parallel to the axis of rotation. While the knife carrier is moved from the standby position into the cutting position, the setting piston is thus linearly displaced in the sleeve-shaped bearing. In particular, the sleeve-shaped bearing is part of the knife head, so that the sleeve-shaped bearing and the setting device can be moved orthogonally to the axis of rotation of the knife carrier by the lowering device.

It can now be provided that the fixing device acts mechanically directly on the setting piston. In particular, if the actuator of the setting device can be pneumatically activated/acutated, the fixing device can act on a section of the setting piston formed concentrically to the bearing section arranged in the sleeve-shaped bearing. The setting piston can thus have a section that protrudes over the sleeve-shaped bearing in both the standby position and in the cutting position, wherein the fixing device in this protruding section can act with the fixing element on the setting piston, for example.

In particular, if the setting device comprises an electric motor drive, it can be provided that the setting piston comprise a fixing section that is offset in a radial direction relative to the bearing section, wherein the fixing device acts on the fixing section. In this case, it can be provided in particular that the actuator of the setting device be arranged in an axial elongation of the bearing section of the setting piston, and that the fixing section formed in particular integrally with the bearing section be arranged radially offset to the bearing section. The fixing section can here be arranged outside of the sleeve-shaped bearing. As a consequence, the drive of the setting device and the fixing device can be arranged offset relative to each other in a radial direction of the bearing section. In this conjunction, it is provided in particular that both the actuator of the setting device as well as the fixing device be immovably connected with the sleeve-shaped bearing for the bearing section of the setting piston, so that the setting piston can be moved into the bearing by the actuator, and the setting piston can be fixed by the fixing device.

The invention along with the technical environment will be exemplarily described below based on the figures. Schematically shown on:

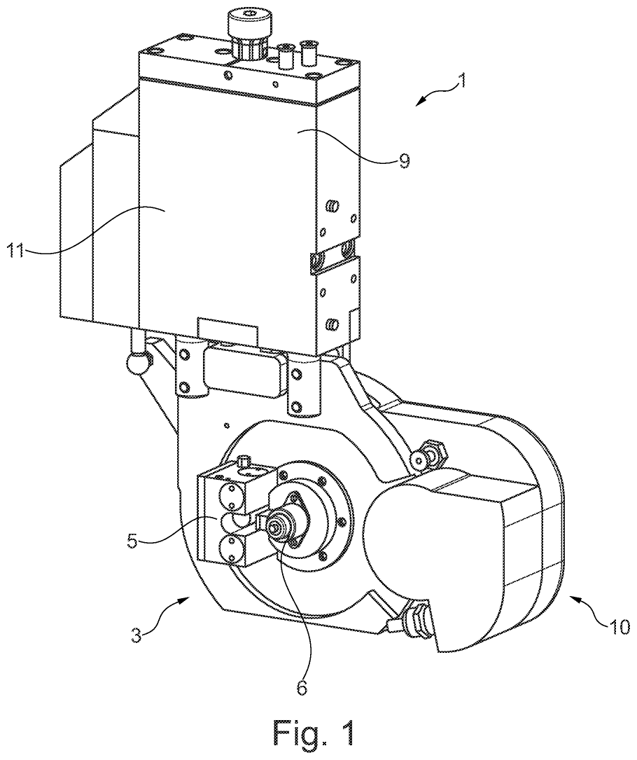

FIG. 1: is a knife holder,

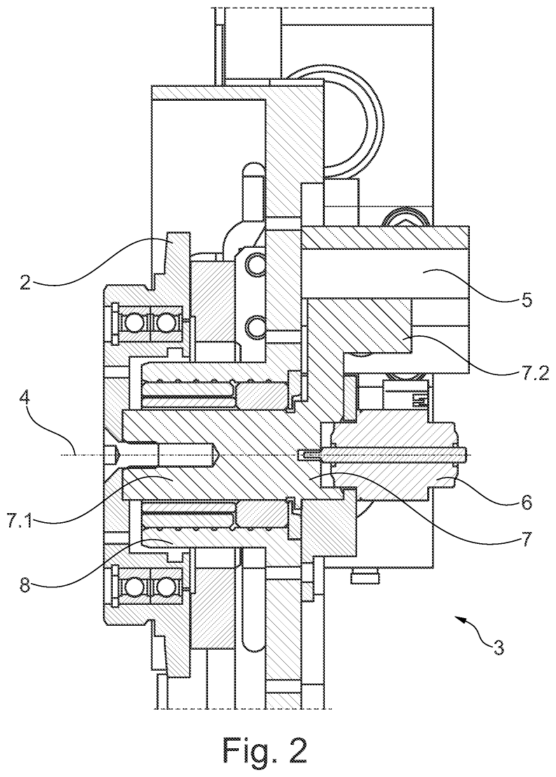

FIG. 2: is a cross sectional view through a knife head of the knife holder, and

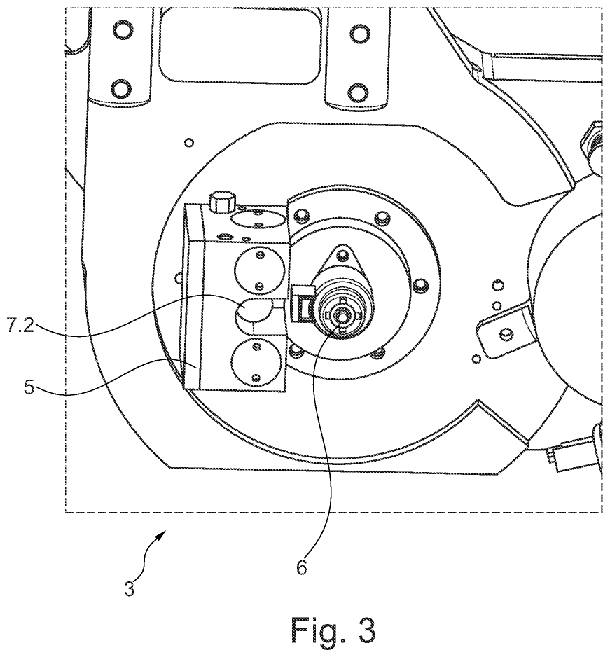

FIG. 3: is a detailed view of the knife head.

The knife holder 1 depicted on the figures comprises a housing 11, which can be used to fasten the knife holder 1 to a traverse of a longitudinal cutting machine.

The knife holder 1 additionally comprises a knife head 10, which can be lowered by means of a lowering device 9 arranged in the housing 11 on FIG. 1.

As evident in particular from FIG. 2, the lowerable knife head 10 comprises a knife carrier 2, which is rotatably mounted around an axis of rotation 4 relative to a setting piston 7 of a setting device 3. The setting piston 7 is mounted in a bearing 8 so that it can be linearly displaced in the direction of the axis of rotation 4.

The setting device 3 additionally comprises an actuator 6, which is designed as an electric motor in the exemplary embodiment of the figures. The bearing piston 7, and hence the knife carrier 2, can be moved parallel to the axis of rotation 4 between a standby position and a cutting position by means of the actuator 6.

Apart from a central bearing section 7.1 arranged in the bearing 8, the bearing piston 7 comprises a fixing section 7.2, which is arranged radially offset to the bearing section 7.1, allowing the fixing section 7.2 to extend next to the actuator 6.

The knife holder 1 additionally comprises a fixing device 5, into which the fixing section 7.2 of the setting piston 7 engages. The fixing device 5 comprises a fixing element, which can be moved between a fixed state and a released state. In the fixed state, the fixing section 7.2 of the setting piston 7 is non-positively clamped by the fixing element, so that the entire setting piston 7 is fixed in its position.

As a consequence, the knife carrier 2, and hence a circular knife fastened to the knife carrier 2, can be adjusted to a counter-knife in a force-controlled manner in the direction of the axis of rotation by means of the actuator 6, wherein the knife carrier 2 can be fixed in its position by means of the fixing device 5 after the cutting position predetermined in particular by a cutting force has been reached. During the cutting process, the knife carrier 2 can thus not move parallel to the axis of rotation 4, as a result of which forces acting on the actuator 6 are also reduced during the cutting process.

### REFERENCE LIST

1 Knife holder
2 Knife carrier
3 Setting device
4 Axis of rotation
5 Fixing device
6 Actuator
7 Setting piston
7.1 Bearing section
7.2 Fixing section
8 Bearing
9 Lowering device
10 Knife head
11 Housing

1. A knife holder (1) for cutting machines, with
a knife carrier (2) rotatably mounted around an axis of rotation (4) for holding a knife,
and a setting device (3) for the knife carrier (2), wherein the knife carrier (2) can be driven by the setting device (3) parallel to the axis of rotation (4) between a standby position and a cutting position,
characterized in that
the knife holder (1) comprises a fixing device (5) that can be actuated independently of the setting device (3), with which the knife carrier (2) can be fixed in the cutting position in the direction of the axis of rotation (4).

2. The knife holder (1) according to claim 1, wherein the fixing device (5) non-positively and/or positively fixes the knife carrier (2) in the cutting position.

3. The knife holder (1) according to claim 1, wherein the fixing device (5) can be mechanically, electrically, pneumatically, or hydraulically actuated.

4. The knife holder (1) according to claim 1, wherein the setting device (3) comprises an electrically, pneumatically, or hydraulically actable actuator (6).

5. The knife holder (1) according to claim 1, wherein the setting device (3) comprises a setting piston (7) to which the knife carrier (2) is rotatably mounted.

6. The knife holder (1) according to claim 5, wherein the fixing device (5) acts mechanically on the setting piston (7).

7. The knife holder (1) according to claim 6, wherein the setting piston (7) comprises a bearing section (7.1) that can be axially displaced into a sleeve-shaped bearing (8) and a fixing section (7.2) that is offset in a radial direction relative to the bearing section (7.1), wherein the fixing device (5) acts on the fixing section (7.2).

8. The knife holder (1) according to claim 1, wherein the knife holder (1) comprises a controller, by means of which the knife carrier (2) can be moved from the standby position into the cutting position in a force-controlled manner.

9. The knife holder (1) according to claim 1, wherein the knife holder (1) comprises a lowering device (9) for a knife head (10) having the knife carrier (2).

10. The knife holder (1) according to claim 9, wherein the setting device (3) can be lowered with the knife carrier (24).

11. The knife holder (1) according to claim 9, wherein the knife holder (1) comprises several knife heads (10) each having a knife carrier (2), which can together be lowered with precisely one lowering device (9).

12. The knife holder (1) according to claim 1, wherein the knife carrier (2) is mounted in a housing (11) of the knife holder (1) so that it cannot be adjusted orthogonally to the axis of rotation (4).
